(19) United States
(12) Patent Application Publication
(10) Pub. No.: US 2012/0140394 A1
(43) Pub. Date: Jun. 7, 2012

(54) ELECTRONIC DEVICE AND KEYBOARD MODULE THEREOF

(75) Inventors: Kun-Chin Chiu, Taipei (TW); Mei-Fang Chou, Taipei (TW)

(73) Assignee: ASUSTEK COMPUTER INC., Taipei City (TW)

(21) Appl. No.: 13/308,503

(22) Filed: Nov. 30, 2011

Related U.S. Application Data
(60) Provisional application No. 61/419,261, filed on Dec. 3, 2010.

(51) Int. Cl. G06F 1/16

(52) U.S. Cl. 361/679.08

(57) ABSTRACT

An electronic device includes a casing, a circuit board, a plurality of connecting elements and a keyboard module. The circuit board is disposed at the casing, and the connecting elements connect the circuit board and the casing. Each of the connecting elements includes a stopper, and the circuit board is disposed between the stopper and the casing. The keyboard module is disposed on the casing, and the stopper supports the keyboard module.

### CROSS-REFERENCE TO RELATED APPLICATION

This application claims the priority benefits of U.S. provisional application Ser. No. 61/419,261, filed on Dec. 3, 2010. The entirety of the above-mentioned patent application is hereby incorporated by reference herein and made a part of this specification.

### BACKGROUND OF THE INVENTION

1. Field of the Invention

The invention relates to an electronic device and, more particularly, to an electronic device including a keyboard module.

2. Description of the Related Art

A notebook computer usually includes a keyboard module disposed at a host for a user to input. The keyboard module includes a plurality of keycaps, a plurality of sensors and a supporting board. The keycaps and the sensors are disposed at the supporting board, and the keycaps correspond to the sensors, respectively.

Keyboard module assembling methods are various, one of the assembling methods is to fasten a circuit board to the host, and then the keyboard module is put to dispose in an accommodating recess above the circuit board.

In order to prevent the keyboard module from interfering with components at the circuit board, the keyboard module has to keep a distance from the circuit board to avoid the contact therebetween.

Consequently, the keyboard module is suspended above the circuit board. That is, only periphery part of the keyboard module is supported. Thus, the keyboard module needs a stronger casing structure to avoid deformation due to the gravity at the central part.

However, with the pursuit of lighter, thinner and lower cost, the structure strength of the keyboard module is limited. Consequently, when the user strikes the keycaps to make the keycaps contact the sensors for information input, the central part of the keyboard module may be deformed, and other keycaps may sway and shake, which may result in sensing errors and the whole structure unstable. Moreover, the keycaps may sink and float due to the deformation of the supporting board of the keyboard module, and thus the user does not feel comfortable while operating.

### BRIEF SUMMARY OF THE INVENTION

An electronic device including a keyboard module that avoids deformation is disclosed.

An electronic device disclosed herein includes a casing, a circuit board, a plurality of connecting elements and a keyboard module. The circuit board is disposed at the casing, and the connecting elements are connected with the circuit board and the casing. Each of the connecting elements includes a stopper, and the circuit board is disposed between the stopper and the casing. The keyboard module is disposed on the casing, and the circuit board is disposed between the casing and the keyboard module. The stoppers abut against the keyboard module.

The keyboard module includes a supporting board and a plurality of keycaps. The stoppers abut against the supporting board. The keycaps are disposed on the supporting board.

The casing includes a plurality of protruding pillars. The protruding pillars support the circuit board, so that the circuit board does not contact the casing by keeping a gap therebetween. The connecting elements are fastened to the protruding pillars, respectively. Furthermore, the keyboard module keeps a distance from the circuit board of the electronic device, and in an embodiment, the distance equals to a height of the stoppers.

These and other features, aspects and advantages of the present disclosure will become better understood with regard to the following description, appended claims, and accompanying drawings.

### BRIEF DESCRIPTION OF THE DRAWINGS

FIG. 1 is a top view showing an electronic device in an embodiment; and

FIG. 2 is a sectional schematic diagram showing the electronic device in FIG. 1.

### DETAILED DESCRIPTION OF THE EMBODIMENTS

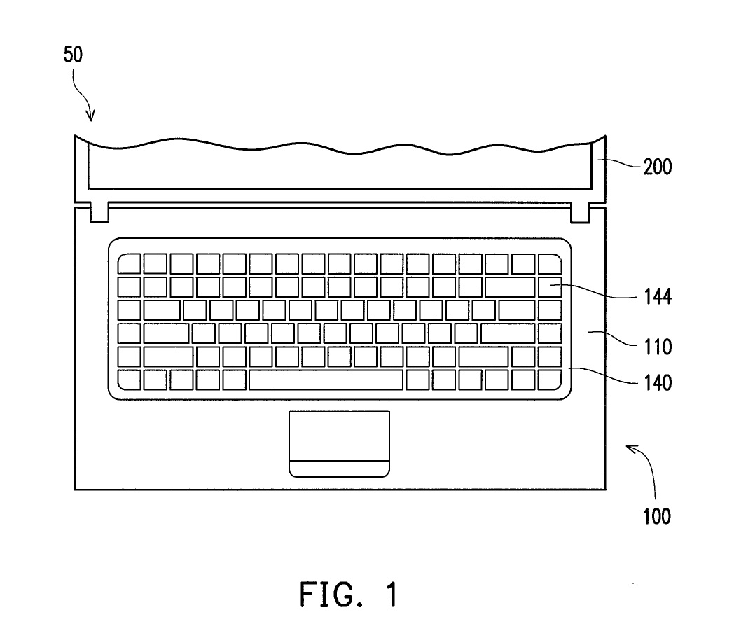

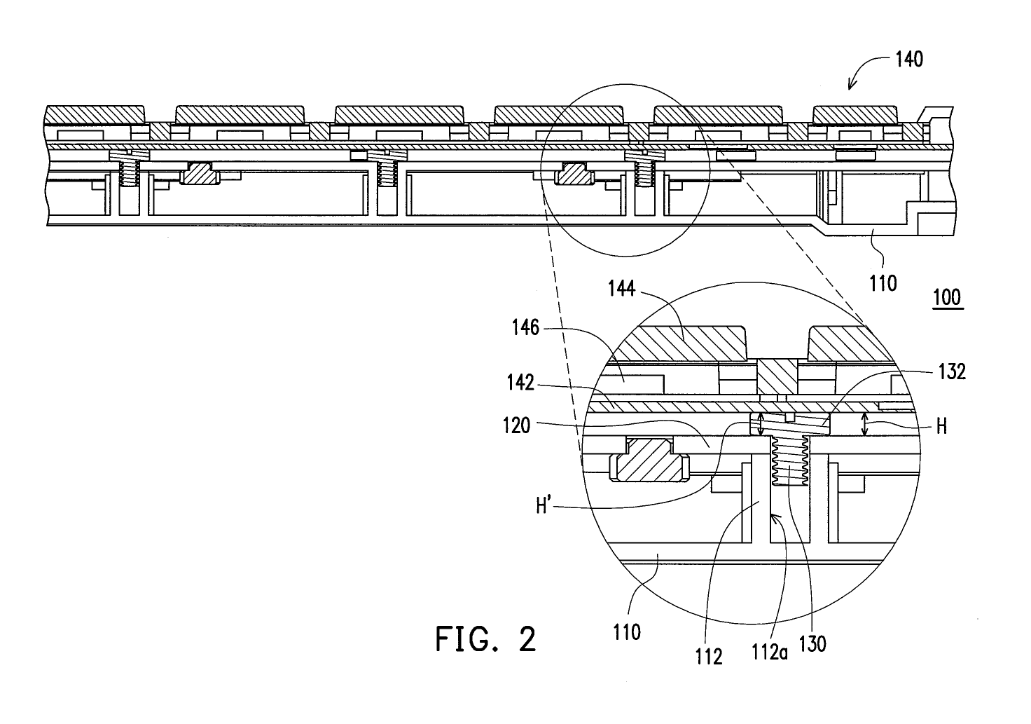

FIG. 1 is a top view showing an electronic device in an embodiment. FIG. 2 is a sectional schematic diagram showing the electronic device in FIG. 1. An electronic device 50 includes a body 100, a casing 110, a display module 200, a circuit board 120, a plurality of connecting elements 130 and a keyboard module 140. The casing 110 may be a casing of an electronic device and includes a space for accommodating the keyboard module 140. The circuit board 120 is disposed at the casing 110, and the connecting elements 130 pass through the circuit board 120 and are fastened to the casing 110.

Each of the connecting elements 130 includes a stopper 132, and the circuit board 120 is disposed between the stopper 132 and the casing 110. The keyboard module 140 is disposed on the casing 110, and the circuit board 120 is disposed between the casing 110 and the keyboard module 140. The stopper 132 of the connecting elements 130 abuts against the keyboard module 140.

The keyboard module 140 may keep a distance H from the circuit board 120 of the electronic device 50, and in an embodiment, the distance H equals to a height H′ of the stopper 132.

In FIG. 2, the keyboard module fastening structure 140 includes a supporting board 142, a plurality of keycaps 144 and a plurality of sensors 146. Circuits can be laid at the supporting board 142 for electrically connecting the keycaps. The keycaps 144 are disposed on the supporting board 142, the sensors 146 are disposed between the supporting board 142 and the keycaps 144, and the sensors are corresponding to the keycaps 144. When the user strikes on keycaps, each of the keycaps 144 contacts the corresponding sensor 146 for trigger corresponding process. The stopper 132 of the connecting elements 130 supports the supporting board 142 thus to avoid the deformation while the keyboard is using.

The casing 110 includes a plurality of protruding pillars 112 to make the circuit board 120 keep a distance with the casing 110, and the connecting elements 130 fasten the protruding pillars 112 to the circuit board 120, respectively. Furthermore, each of the protruding pillars 112 includes a fastening part at the top. The connecting elements 130 are connected to the fastening part to fasten the circuit board 120. In an embodiment, the fastening part may be a screw hole 112a, and each of the connecting elements 130 may be a screw. Each of the connecting elements 130 is fastened to the corresponding screw hole 112a to fasten the circuit board 120 to the casing 110. The connecting elements may also be locking parts, rivets, latches, which is not limited herein.

The electronic device 50 may be a notebook computer, a portable device or other electronic devices including a keyboard module, which is not limited herein.

In sum, the connecting elements fasten the circuit board 120 to the casing 110, and the stopper 132 supports the supporting board of the keyboard module 140, thus the deformation of the keyboard module 140 under external force such as strike on keycaps can be avoided. Consequently, the keyboard module 140 is more stable for users to operate in a better experience.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device, comprising:
a casing;
a circuit board disposed at the casing;
a plurality of connecting elements connecting the circuit board and the casing, wherein each of the connecting elements includes a stopper, and the circuit board is disposed between the stopper and the casing; and
a keyboard module disposed on the casing, wherein the circuit board is disposed between the casing and the keyboard module, and the stoppers supports the keyboard module.

2. The electronic device according to claim 1, wherein the keyboard module includes:
a supporting board, wherein the stoppers supports the supporting board; and
a plurality of keycaps disposed on the supporting board.

3. The electronic device according to claim 1, wherein the casing includes a plurality of protruding pillars, and the connecting elements are connected to the protruding pillars.

4. The electronic device according to claim 1, wherein the electronic device further includes a display module, and the display module is pivotally connected to the casing.

5. The electronic device according to claim 1, wherein the keyboard module keeps a distance from the circuit board, and the distance equals to a height of the stoppers.

6. A keyboard module fastening structure applied to an electronic device, comprising:
A plurality of connecting elements fastened to the electronic device, wherein each of the connecting elements includes a stopper; and
a keyboard module disposed at the electronic device, wherein the stoppers supports the keyboard module.

7. The keyboard module fastening structure according to claim 6, wherein the keyboard module includes:
a supporting board, wherein the stoppers supports the supporting board; and
a plurality of keycaps disposed on the supporting board.

8. The keyboard module fastening structure according to claim 7, wherein the supporting board of the keyboard module contacts the stoppers.

9. The keyboard module fastening structure according to claim 6, wherein the keyboard module keeps a distance from a circuit board of the electronic device, and the distance equals to a height of the stoppers.
